(19) United States
(12) Patent Application Publication
(10) Pub. No.: US 2013/0212465 A1
(43) Pub. Date: Aug. 15, 2013

(54) POSTPONED RENDERING OF SELECT WEB PAGE ELEMENTS

(71) Applicant: Alexander Kovatch, Las Vegas, NV (US)

(72) Inventor: Alexander Kovatch, Las Vegas, NV (US)

(21) Appl. No.: 13/761,553

(22) Filed: Feb. 7, 2013

Related U.S. Application Data
(60) Provisional application No. 61/596,922, filed on Feb. 9, 2012.

(51) Int. Cl. G06F 17/22

(52) U.S. Cl. CPC G06F 17/2247
USPC 715/234

(57) ABSTRACT

Method and apparatus for optimizing web page performance and/or enhancing user privacy by selectively delaying the loading and/or rendering and/or execution of specific web page elements until such time when the user specifically enables and/or interacts with and/or requires functionality of said elements.

### CROSS-REFERENCE TO RELATED APPLICATIONS

This application claims priority to Provisional Patent Application No. 61/596,922, filed Feb. 9, 2012, entitled “Postponed Rendering of Select Web Page Elements” and is incorporated by reference in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The present application relates to methods and systems that increase browser performance. Also disclosed is an extensible approach that offers flexibility with user control regarding privacy.

2. Description of the Related Technology

Currently, performance and privacy goals can be met by altering the specific content loaded and rendered by a browser engine. Examples of specific elements identified as causing performance and/or privacy concerns specifically include but are not limited to, the fields of online advertising, tracking of online users, social networking, and browser cookies. There are hundreds, if not thousands, of publications related to what can be tracked online (e.g. visits, keystrokes, mouse movements, purchases, social relationships, location, machine type, screen resolution, and many other statistics), how the tracked data can be used (e.g. targeted advertising, content selection, usage analytics, etc.), methods for end users to share content socially, as well as, but not limited to, specific methods and systems to implement such embodiments. Generally, the goal of the disclosed embodiments is to circumvent and/or disable these methods.

Enterprising individuals and companies have implemented standalone software, browser extensions or other add-ons that augment standard browser behavior to block ads, delete browser cookies, selectively control execution of script, and block communication and the exchange of information with social networking companies such as Facebook or advertising companies such as Google. Unfortunately, simply deleting content, blocking and/or deleting cookies, disabling script or filtering HTTP requests can cause layout problems with how the page is displayed, take away from the web designer's message or even render the page useless. Then there are also times when users do want to have the ability to use social networking buttons, for instance, Facebook's ‘Like’ button to quickly ‘Like’ some content and share it socially with the click of a button. When a user ‘Likes’ some content on Facebook, a story is added to the user's Facebook wall so that his or her friends can see it. This behavior expected by the user but the issue for those concerned with privacy is that simply having these social networking buttons, ads, etc. on web pages can and usually do track users whether they are a user of the given social network or not. Script-blocking add-ons and extensions can potentially speed up page display and enhance privacy; however, even with the knowledge of a skilled programmer, users can end up stuck in a trial-and-error loop, trying to determine what to allow and what to block in order to get the desired parts of the page to display. In some cases, this can eventually lead the user to just enable everything, thus defeating the purpose of the add-on or extension.

### BRIEF DESCRIPTION SUMMARY OF CERTAIN INVENTIVE ASPECTS

The system, method, and devices disclosed herein each have several aspects, no single one of which is solely responsible for its desirable attributes. Without limiting the scope of the disclosed invention(s) as expressed by the claims, which follow, its more prominent features will now be briefly discussed. After considering this discussion, and particularly after reading the section entitled “Detailed Description of Certain Embodiments” one will understand how the features of the invention(s) provide advantages that include improved user control over loading of webpage elements resulting in increased browser performance and more control over user privacy.

One embodiment is a method including receiving a web page description, identifying original elements that can be optimized, transforming the elements, replacing the original elements with optimized elements, and outputting a new page description, wherein the optimized elements are rendered. The identified elements can be stored so that the original, unoptimized elements can be enabled later. The identified elements can be elements which degrade performance or share identifying information. The optimized elements can improve performance of web page rendering or hide identifying information. The optimized elements, when rendered, can be visually similar to the rendered result of the original, unoptimized elements that were replaced, preserving an intended page layout.

Another embodiment is a method including receiving a rendered web page containing a rendered result of optimized elements and information necessary to enable original, unoptimized elements, waiting for an event, transforming the rendered web page, replacing the rendered result of the optimized elements with the original, unoptimized elements; and rendering the original, unoptimized set of elements, thereby generating the originally specified web page. The method can further include capturing the event, wherein the event is one for which the rendered result of the original, unoptimized elements would be listening if it had it been rendered, waiting for the unoptimized elements to finish rendering; and sending the event to the rendered result of the original, unoptimized elements. The event can be a click on the rendered result of the optimized elements, resulting in a single-click interface for both activating the original, unoptimized elements and sending a click event to the rendered result of the originally specified, unoptimized elements.

Yet another embodiment includes a system comprising at least one non-transitory memory, one or more processors, one or more network interfaces, logic encoded such that the processors intercept web page descriptions, identify original elements that can be optimized and transform the original elements, replacing the original elements with optimized elements, generating a modified web page description. In one embodiment, the system is providing web browsing functionality and also comprises one or more output interfaces, and one or more input interfaces, wherein the processors render the modified web page description on the one or more output interfaces. In one embodiment, the system can serve the role of one of a web application server, an intermediary server such as a proxy server, virtual private network (VPN) or an internet service provider (ISP); and the modified web page description is returned to a requestor via the one or more network interfaces. The identified elements can be elements that degrade performance or share identifying information. The optimized elements can improve performance of web page rendering or hide identifying information. The optimized elements reference elements which can load from optimized locations including at least one of the system's non-transitory memory, an alternate third party server, a local resource of the browser rendering the page, and as binary data encoded and included inline in the optimized page description. The optimized elements, when rendered, are visually similar to the rendered result of the original, unoptimized elements that were replaced, preserving the intended page layout. In one embodiment, the processors store the identified elements in the non-transitory memory so that they can be enabled and rendered later.

In one embodiment, the system further comprises a modified web page description including the identified elements needed to enable the original, unoptimized elements which were replaced along with instructions which, when executed by a web browser, can enable and render the original, unoptimized elements. An event can trigger the processors to enable the original, unoptimized elements. In one embodiment, the processors capture an event, wherein the event is one for which the rendered result of the original, unoptimized elements would be listening if it had been rendered, enable the original, unoptimized elements, wait for the original, unoptimized elements to finish rendering, and send the event to the rendered result of the original, unoptimized elements. The event can be a click on the rendered result of the optimized elements, resulting in a single-click interface for both activating the original, unoptimized elements and sending a click event to the rendered result of the originally specified, unoptimized elements.

### BRIEF DESCRIPTION OF THE DRAWINGS

FIG. 1A is a flow diagram which shows one example of the current load/render method implemented in current web browsers (prior art).

FIG. 1B is a flow diagram which shows one example of the load/render method with the addition of the steps detailed in this disclosure.

FIG. 1C shows example HTML snippets which could be identified, along with possible replacements.

FIG. 2 is a flow diagram which shows the steps to enable and inject elements back into an HTML page which was optimized by the updated load/render method of the disclosure.

FIG. 3A is a flow diagram which shows what happens after there is some event or interaction with a web page in current web browsers without the disclosed systems and methods (prior art).

FIG. 3B is a flow diagram which shows the novelty added by this disclosure to handle a user interaction dynamically with a one-click user interface.

FIG. 4 is block diagram illustrating how the embodiments can be applied or implemented.

FIG. 5 is a block diagram illustrating a system architecture of the embodiments.

FIG. 6A is a combination block/flow diagram which shows how the inventive aspects work and where specifically the individual functions would execute when implemented as part of a system executing a browser program.

FIG. 6B is a combination block/flow diagram which shows how the inventive aspects would work and where specifically the individual functions would execute when implemented as part of an intermediary system such as a VPN (Virtual Private Network) server, proxy server or at an ISP (Internet Service Provider).

FIG. 6C is a combination block/flow diagram which shows how the inventive aspects would work and where specifically the individual functions would execute when implemented as part of a web application server system.

FIG. 7 is a sample timeline of a web page load including example times for each operation.

### DETAILED DESCRIPTION OF CERTAIN EMBODIMENTS ORGANIZATION AND PRESENTATION

Set out below, an overview of the invention is provided. Following, a description of the current technology is given for two aspects of the embodiments. Next, certain embodiments are described in detail. For increased comprehension, code snippets are presented followed by a block diagram further detailing how the invention applies to a specific example. Next, a system is described along with multiple example systems. Next, advantages of the invention are presented along with details on how the invention impacts performance as measured by load time. Finally, details are presented to describe how the invention adapts to the future.

This document uses common terms such as “element”, “render” and “event” which have specific meanings in the art.

An HTML element is an individual component of an HTML document. HTML documents are composed of a tree of HTML. Each element can have attributes specified. Elements can also have content, including other elements and text. HTML elements represent semantics, or meaning. For example, the <img> element represents an image in the document and a <script> element represents a block of script code.

As described by Wikipedia, http://en.wikipedia.org/wiki/Web browser engine, a web browser engine, (sometimes called layout engine or rendering engine), is a software component that takes marked up content (such as HTML, XML, image files, etc.) and formatting information (such as CSS, XSL, etc.) and displays the formatted content on the screen. It “paints” on the content area of a window, which is displayed on a monitor or a printer or even presented audibly. A web browser engine is typically embedded in web browsers, e-mail clients, on-line help systems or other applications that require the displaying (and editing) of web content. For the purpose of this document the term “rendering” is used to denote the process of converting HTML elements into their final form and thus presenting them as output, for example, on some output device. During this rendering, script code may be executed which can create more script code and/or elements which repeat the process, possibly indefinitely. When applicable, “elements” are distinguished from the ‘original element’ and the ‘rendered result of the original element’, still a set of elements but now possibly in an expanded state once custom script and rendering code has executed. For example, the custom tag which draws a Facebook Like button (<fb:like> would be an element and once rendered the page contains many elements, e.g. a <span> wrapping an <iframe> which is filled with all the HTML elements that define the styles, images, etc. that draw the button along with <script> elements that facilitate communication with Facebook servers and implement the desired functionality.

Events can include mouse events (e.g. click, mouseover, etc.), keyboard events (keydown, keypress, etc.), HTML frame/object events (load, resize, scroll, etc.), HTML form events (submit, change, blur, etc.) and other Document Object Model (DOM) or custom events. Events allow event-driven programming languages like JavaScript, JScript, ECMAScript, VBScript and Java to register various event handlers/listeners on the elements inside a DOM tree, e.g. HTML, XHTML, XUL and SVG documents. The event model was standardized by the World Wide Web Consortium (W3C) in DOM Level 2.

### OVERVIEW OF INVENTION

The following detailed description is directed to certain specific implementations or embodiments. However, the embodiments disclosed herein can be embodied in a multitude of different ways as defined and covered by the claims. In this description, reference is made to the drawings wherein like parts are designated with like numerals throughout.

The foregoing disclosure details a method and system to enhance web browser performance and/or increase user privacy by optimizing the page that is selectively loading and rendering only the necessary parts of the page as required by the user. Furthermore, the embodiments provide a method and system so that the optimized page can retain all of the functionality, look and feel of the original page.

Initially, only elements identified as being ‘required’ in the most general case and/or which do not share private information about the user are loaded and rendered. While it is not possible to read the user's mind to know exactly what features of a web page will be ‘required’ during a given session, it is likely that, for example, a social networking button is not a required feature for viewing a web page with a news story. Additional elements are then loaded and rendered as requested by other events or interactions that the user has with the page. In one embodiment, one or more of the removed elements might be replaced with a placeholder which could visually appear exactly the same as the original element but without accessing a web application server at all. Unnecessary, poorly performing and privacy-violating elements can then be dynamically loaded and rendered to provide additional functionality as needed or as requested. In many cases, less than one-third of the total data transferred and elapsed time used to load and render a web page is directly attributed to the primary domain and to what end users would likely consider the main content. The rest of the data and time in a typical page request are used to do things such as display ads, display social networking buttons, track user interactions and collect other analytics for the web master and for advertisers. This other block of time and data benefits the web master and advertisers but arguably does little for the end user.

More specifically, in the disclosed embodiments, data requests are pre-processed before being passed along to the browser's rendering engine. Elements in the data stream which are not part of the primary content are identified and replaced with an optimized implementation, for instance, a placeholder or other optimized implementation which can load from local storage. An optimized implementation is, for example, one in which these identified elements are removed or altered so that they use no resources. The replacement could even be nothing, or null, essentially removing the original, or unoptimized elements, from the stream completely. In the case when a user never interacts with or requires the functionality provided by these additional elements, the optimization of not loading elements which are not needed can result in substantial time savings with regard to browser performance. Stated another way, a system which executes zero instructions and loads zero bytes of data, making zero HTTP requests will always be faster than a system that executes some number of instructions and loads some bytes of data. In addition, user privacy can be enhanced because information-gathering script code blocks, beacon images and other means of tracking user data or sharing personal information can be eliminated from the page before the page is rendered, thus circumventing these methods until the user decides to enable them. For example, consider how the Facebook ‘Like’ button works in the system described herein. The script that loads and displays the ‘Like’ button would not exist in the page, would not run, would not share information about the user with the Facebook server, and would not even exist in the browser's memory until the user clicked the placeholder for the ‘Like’ button. Stated a different way, with the embodiments taught herein, data is only shared when the user makes a specific action to enable parts of the web page which might share personal information about the user, unlike the default behavior which can begin sharing personal information as soon as the page loads and renders. With respect to privacy, the concern is over the allowing of specific script/code to run in the user's browser, loading of some hidden ‘beacon’ image, ad or social networking button, any of which can facilitate the sharing of private information about the user. No specific action is required by the user, as simply visiting a page that contains one of these elements has the potential to share private user information.

So much has been made about deleting browser cookies to protect a user's privacy; however, cookies do provide a useful purpose, particularly on the primary domain. If the code or elements which access the cookies from third party domains are eliminated and/or disabled, then user privacy is maintained, as cookies are never created, accessed, or updated by third party servers. With this implementation, privacy from third party sites (e.g. advertisers, social networks, etc.) can be achieved transparently to the user, preserving the core browsing experience and functionality without having to intermittently perform a wholesale deletion of all cookies.

In the case when the user requires the functionality of some element or group of elements, the optimized elements (e.g. placeholder) can be replaced by the original elements, which can be loaded and rendered dynamically. Keystrokes, mouse-clicks, etc. can be caught by the placeholder and passed along to the rendered result of the original elements so that the end user would not be aware of any changes from a functional interaction standpoint. Furthermore, if the placeholder looked visually identical to that of the rendered result of the original, unoptimized elements or group of elements that were removed then the end user would most likely not even be aware of this change from a visual standpoint either, allowing a seamless delayed rendering of the original elements. Lastly, if this placeholder has the ability to capture events, trigger the replacement and render of the original, unoptimized elements, and then forward the events on to the newly rendered elements then it is possible to have a completely seamless swap from the optimized elements to the original, unoptimized elements. This includes the interaction standpoint as well as the visual standpoint and allows for a one-click interface (described later).

The detailed description of the invention presented herein, describes the method and system necessary to implement all the embodiments by someone skilled in the art at the time of the filing of this application. Specific programming methods and system design and are offered as examples only and not intended to describe the only implementation and system possible.

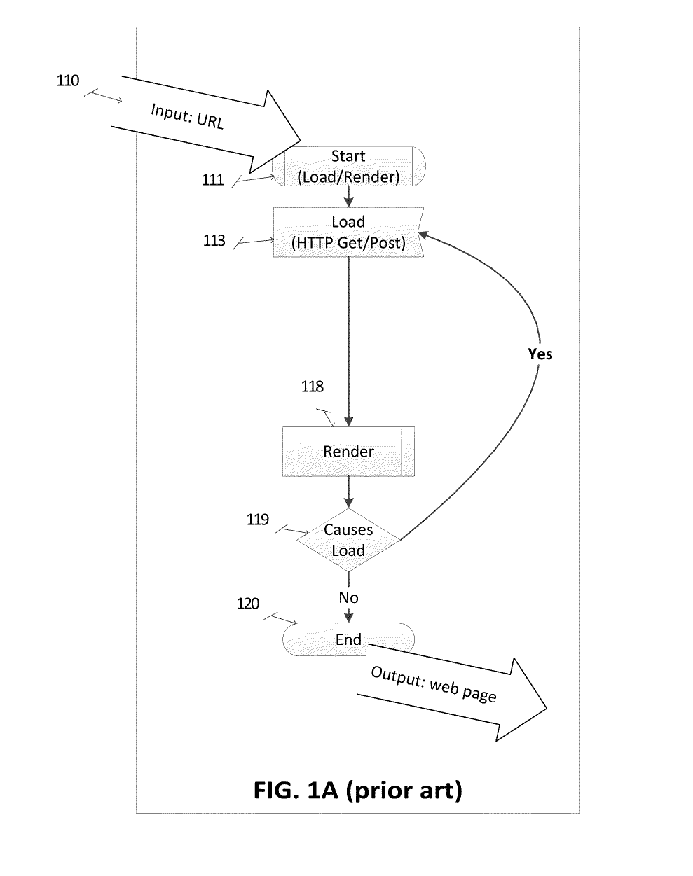

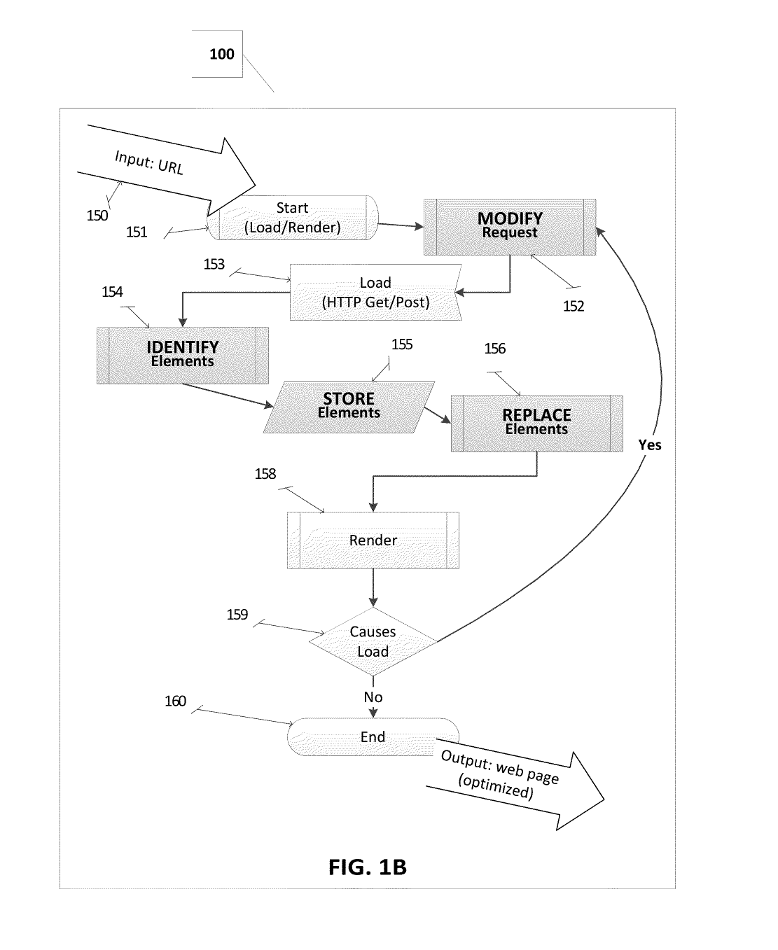

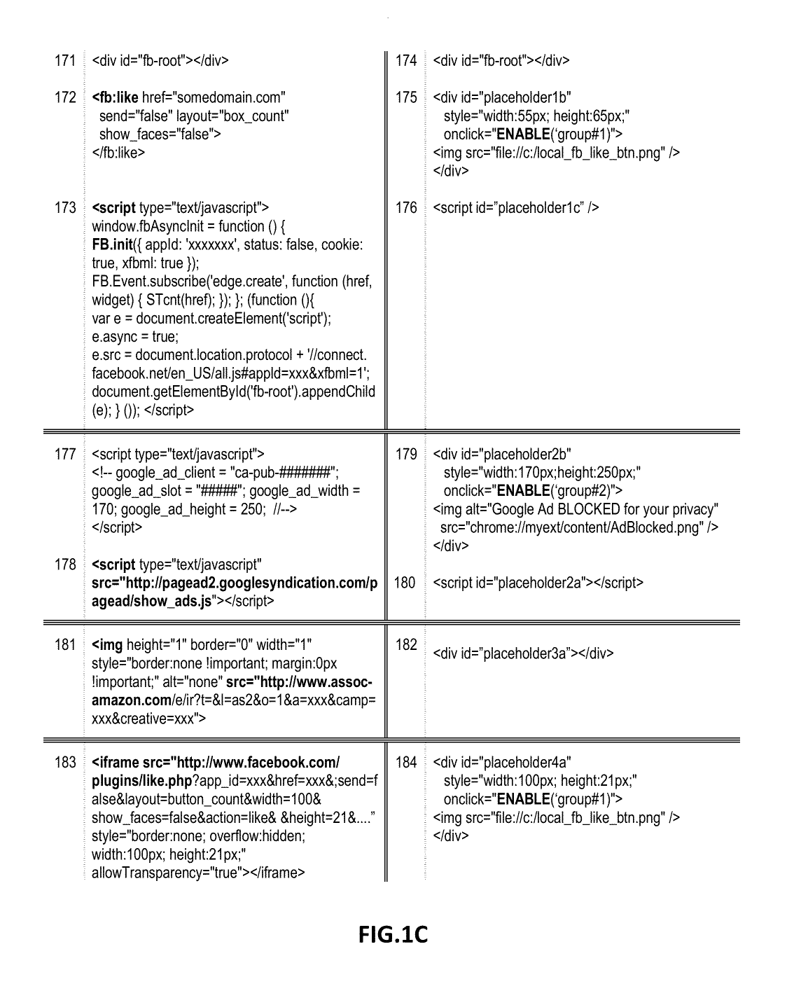

FIG. 1A shows an example of a current, popular method used to load and render a web page given a URL (Universal Resource Locator) address can be basically the same for all web browsers on all hardware/software platforms. This method can be described as the current state of the art. Given some input URL 110, the input URL is received at block 111, and the load/render procedure is initiated. At block 113, the initial page is loaded. The initial page is most commonly delivered by a web application server via the HTTP protocol, and it describes a layout of elements using HTML markup as defined by the World Wide Web Consortium (W3C) plus any custom markup. The term “element” can be defined as any valid HTML tag, custom tag, script code, group or combination thereof. The disclosed embodiments work by replacing the elements of incoming documents before they are rendered, transforming the originally specified page into one that has been optimized for enhanced performance and privacy. Elements are technically markup tags and/or script code but the term “element” is also loosely used herein to refer to the output or even binary data which is rendered by such tags and script, specifically, the rendered output of the elements. Elements would therefore include html documents, images, script blocks, objects, frames, audio files, fonts, css style sheets, etc.

Once the initial page is loaded at block 113 it is then rendered 118. Rendering certain elements such as script blocks and objects can cause the creation of new elements that would again need to be loaded and rendered and if so, at block 119, the process returns to block 113 to repeat, adding to the output rendered so far until there are no further causes to load and the method ends at block 120. In some situations, this looping back to the load process 113 might never end, for example, when some script block on a page continues to alternate news headlines indefinitely.

### Load/Render Method

FIG. 1B shows one example of a method 100 used by a browser to display a web page, given a URL address and certain parameters with the additional functions of the disclosed embodiments added. The method 100 is an improvement over current methods known in the art because of the addition of four specific functions which are described in detail below: the MODIFY, IDENTIFY, STORE, and REPLACE functions. Method 100 begins at block 151 where the input URL 150 is received, and the load/render 151 is initiated.

At block 152, a request is modified. Before any HTTP requests are made, HTTP headers and the URL are evaluated and potentially modified at block 152 to circumvent the unintentional passing of private information and/or to optimize page loading. Modifications can include but are not limited to changing the value of HTTP header variables including ‘referer’ (referred to as it is because it is misspelled in the W3C specification), cookies and information about the browser's environment, operating system, screen resolution, browser plug-ins enabled, fonts loaded, time zone, etc. Even URL parameters might be modified to remove identifying information about the user. In one embodiment, specific headers like ‘referer’ can be removed before the request is sent in order to protect privacy by hiding from third parties which web site a request came. For example, a user might want to watch an embedded YouTube® video on some web page but not want YouTube® to know that the video was viewed from a page on a specific domain. In some cases there could also be a performance advantage because certain requests can be killed here or the URL could be modified to point to a new location with an optimized implementation, maybe even a local resource.

At block 153, the load request is initiated and the initial page description is loaded. Moving to block 154, the purpose of the IDENTIFY function 154 can be to detect elements that can cause issues with privacy and/or performance. The IDENTIFY function 154 can be implemented by many approaches or a combination of them. In one embodiment, regular expressions, a common technique used in writing parsers, are used to process the raw HTML, identifying signatures that match relevant blocks. For example, the following regular expression finds an HTML input tag with a password type:

<\binput\b[̂>]*?type=([′″])?password\1\w

In another embodiment, raw HTML can be loaded into the built-in XML DOM (Document Object Model) and XML DOM functions can be used to query for specific elements that can be evaluated independently. For example, the following function could be used to get all script elements and then the ‘src’ attribute could be evaluated to check for reference to specific domains:

var elem = doc.getElementsByTagName(‘script’);
if (elem.src == ″....

In yet another embodiment, string functions are used to identify and evaluate raw HTML. The following code finds the beginning and end of an object tag within a string buffer (strHtml) containing the HTML of a page:

var start = strHtml.indexOf(“<object”);
var end = strHtml.indexOf(“</object”, start + 7);

The IDENTIFY function 154 utilizes multiple iterations of multiple methodologies to identify all relevant elements and collections of elements.

The IDENTIFY function 154 identifies elements and groups of elements that can work together to degrade performance, implement unused functionality, and/or potentially invade the user's privacy. In one embodiment, many categories of elements or groups of elements are identified: (1) script blocks or code blocks, (2) elements that load from third party domains and (3) custom tags which extend the W3C's HTML specification. In one embodiment, all elements identified would fit into one or more of these categories; however, the grouping is not meant to be a finite set or the only grouping. Stated another way, any element or set of elements which arguably degrade performance or for which there could be a more optimal implementation from a load time or processor usage perspective would be detected by the IDENTIFY function 154, as well as any element or set of elements that potentially share private information about the user or could be used in conjunction with other information to identify the user. Private information includes but is not limited to keystroke or mouse logs, browsing history, usage information, account information, machine statistics, ip address, cookies, etc.

Previously, in the background section, it was noted that there are hundreds if not thousands, of publications related to what can be tracked online (e.g. visits, keystrokes, mouse movements, purchases, social relationships, location, machine type, screen resolution, and many other statistics), how the tracked data can be used (e.g. targeted advertising, content selection, usage analytics, etc.), methods for end users to share content socially, as well as, but not limited to, specific methods and systems to implement such embodiments. The IDENTIFY function 154 detects all these methods so that they can be circumvented and rendered useless, each potentially requiring and/or utilizing different methods of detection or a combination thereof. With so many implementations to circumvent, this might seem like an impossible task but the list of language constructs on which these methods are implemented is actually small (e.g. headers, script code and references) and arguably finite. As headers are dealt with in the MODIFY function 152, we will move along to discuss script and references.

Script or code blocks are defined in HTML/XHTML by opening (<script . . . ) and closing (</script>). Here any code referenced or defined inside the script blocks can be evaluated against the likeness or signatures of known blocks. Briefly jumping to FIG. 1C, some example HTML snippets that could be identified, along with their possible replacement values as disclosed herein are shown. For example, a script block might contain reference to a known Facebook library function like FB.init 173. Script blocks like this are usually given to the web site developer by third parties, and the exact behavior, features, and implementation are often unknown to the web site developer because it's common for such code to dynamically load more script and elements from the third party's web server. For example, the code that runs in social networking controls like the Facebook Like button could share information with the Facebook servers and its affiliates about the pages that a certain user visited, what the user typed or clicked on, etc. The possibilities are virtually endless and could easily include anything from turning on the user's web cam to logging keystrokes including credit cards and passwords—for every page on every site where the social networking control appears.

References are another way for web pages to communicate with third parties through web page elements that reference features, objects, code, etc. on third party servers. These references can be as simple as, for example, pinging a beacon image to let Amazon's ad server know that a user saw a certain ad, for example, the code snippet 181 to something more sophisticated like dynamically loading an entire page into an iframe as implemented in the Facebook Like button 183 or loading script that when executed displays a targeted ad from a Google ad server 178. The capabilities of third party references depend on the specific HTML element but any element which includes the ability to reference third party servers has at least the capability to notify some third party server that a user was looking at some page or some site. Specific HTML elements capable of communicating with third party servers include but are not limited to the following tags: img, script, object, iframe, link, frame and new HTML5 tags such as embed, video, audio, track and source. As important as the potential privacy issues these third party references might cause, is the negative performance penalty they can introduce because of many round-trips to different servers can be required to complete the rendering of such elements. There are domain lookups from DNS servers, downloading of objects, and execution of code which might cause the entire load/render process to begin again.

Besides the standard HTML tags there are also custom tags which are not defined in the W3C's spec but extend the specification by including their own specifically loaded rendering functions. Google's +1 button (<g:plusone>) is one example. Facebook also provides an implementation for their social networking controls like the Facebook Like button. Usually is it not necessary to disable these custom tags as long as custom rendering script is not loaded and/or executed but these tags will be detected by the IDENTIFY function 154 because they can present a user interface and therefore might come into play later in the REPLACE function 156 (described later).

The STORAGE function 155 saves all the elements identified previously so that they can be injected, loaded and rendered later. In one embodiment these elements are stored in an in-memory array or stack. In another embodiment they are stored in a database while in another embodiment these stored elements are embedded into and/or sent along with the HTML page itself. The important thing is not the storage mechanism but that these elements can be retrieved again and that the location within the original document is remembered along with the group in which they belong. Here the term ‘group’ could mean set of functionality or simply which third party site the elements came from if it's appropriate to group by site.

The purpose of the last additional action defined in the disclosed embodiment of the load/render method, the REPLACE function 156, is to replace all elements identified and stored previously with an alternate implementation when appropriate. The purpose of replacing these elements can be to provide an optimized and/or privatized implementation. In one embodiment, the replacement might also be an empty placeholder used to mark the space where the element was removed from.

For example, consider a script block 173 (FIG. 1C) that renders the custom Facebook ‘Like button’ control 172 or a script block that dynamically loads and displays an ad 178 or an invisible beacon image 181 which has no visual purpose on the page. For code elements that create some visual representation or elements that directly display some content one embodiment could display local or optimized implementations which visually appear to the user to be identical to that which was replaced. For example, the dynamic script which shares the user's personal information with Facebook's servers generates some code to run in the user's browser and then inserts an image for a Facebook Like button 172-173 or a Facebook Like button implemented in an iframe 183 could be replaced with an image which loads immediately from the local drive 175-176 and 184 respectively. One embodiment can include a library of display code and images to display any social networking control, object or collection of elements handling all possible parameters. It goes without saying that not loading elements and not executing code is much faster than doing so. It also goes without saying that a lot less private information can be shared when communication is completely stopped vs. when it is allowed. In fact, the only way that third parties would be able to get information about this interaction is if the primary web server shared it independently behind the scenes through some other connection. Once all necessary replacements are made the flow continues with the steps of known methods, 158-160 in FIG. 1B which are identical to the equivalently named steps 118-120 previously described along with FIG. 1A.

Putting it all together, referencing again FIG. 1C shows some sample groups of elements that could be identified along with an example of how they could be replaced using method 100. The custom Facebook Like button tag implementation 171-173 contains 3 elements: the root element 171, the custom tag 172, and custom rendering script 173 which turns the custom tag into a visible button with the specified look and features. The disclosed embodiment could change the last two elements to show a new button which loads from some local storage 175 and mark the script element which loads the rendering code with an empty script block 176 to work as a placeholder. The original root element 171 has no visible or interaction capabilities so no replacement is necessary 174.

In one embodiment, a Google advertisement is described with two script blocks. One defines the parameters 177 and the other dynamically loads and renders a targeted ad 178. In one embodiment, these blocks are replaced with a static image 179 and a blank script block 180 to be used as a placeholder.

In another embodiment, an Amazon beacon image 181 could be replaced by an empty div 182 tag which would act as a placeholder.

Finally, another example of the Facebook Like button 183 is implemented with an iframe that dynamically loads from Facebook's server with all the parameters specified in the URL. In this embodiment, the iframe might simply be replace with a static image which loads from some local storage 184.

### Enabling Previously Removed Elements

The novel method 100 described herein to load and render a web page given a URL 150 performs dramatically better than the known method shown in FIG. 1A because selected elements are not loaded, rendered or executed. At some later point, usually triggered by a direct user interaction, these temporarily delayed elements can be injected back into the web page and allowed to render in order to provide the complete functionality intended by the webmaster. In one embodiment, a timer, and not some interaction, triggers the replacement back to the original implementation.

The current approaches to providing enhanced privacy require that the page request needs to be repeated with the blocked protocol(s) now allowed. This means that the page and all referenced resources need to be reloaded and the entire page needs to be rendered again. In addition to the cost of reloading and re-rendering, this is not be the ideal approach because data entered into the screen can be lost. However, for existing privacy solutions that block requests at the protocol level to specific domains this is the only possible approach.

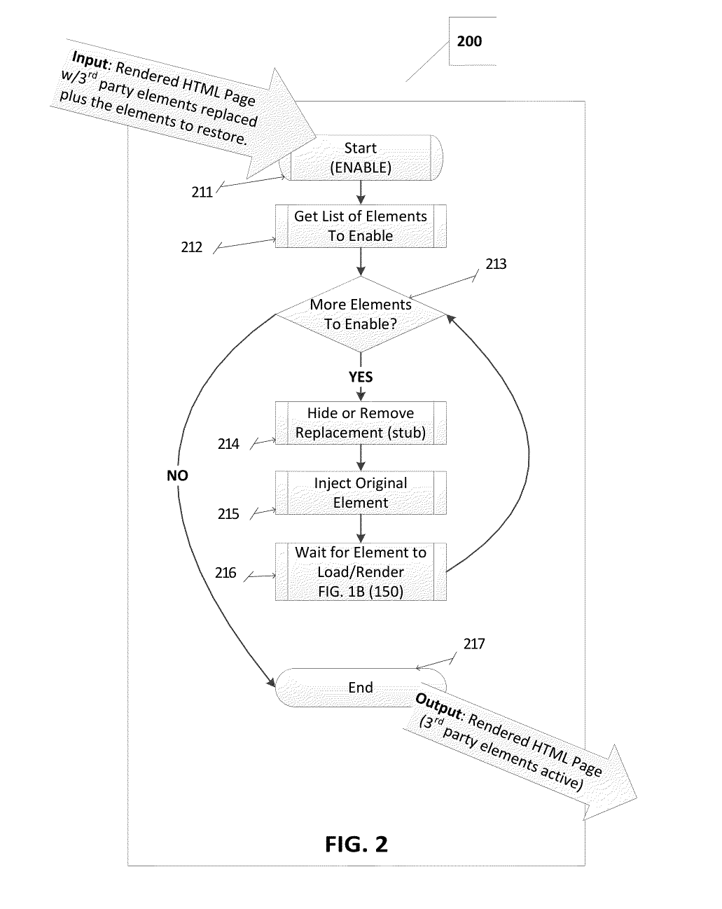

Moving now to FIG. 2, the ENABLE method 200 provides for a much more elegant solution that does not suffer the problems of the existing privacy solutions because it allows for specific elements previously replaced in REPLACE function 156 to be injected back into the page and rendered dynamically, inline and without the need to reload and re-render the page. These newly injected elements are then ready and available to receive events. The ENABLE method 200 starts at block 211 with a rendered page and a list of elements to enable 212 and repeats the following steps for each element being restored: determining that there is an element to enable 213; hide or remove the replacement that currently exists in the page 214; inject the original element back into the page 215 and then wait for the newly injected element to load and/or execute and/or render 216 before looping to block 213 to again check for an element to enable. Finally, at block 217, no elements are available to be enabled and the method 200 ends.

The ENABLE method 200 is different from the MODIFY 152, IDENTIFY 154, STORE 155 and REPLACE 156 functions in one significant way, regardless of system. The ENABLE method 200 acts on a rendered page as opposed to a page description which hasn't been rendered yet, and therefore needs to have access to the DOM (document object model) of the rendered page. Stubs are hidden 214 through the use of browser DOM functions such as removeChild( ) or just visually hidden by using the element's style attributes. The original implementation can be injected back 215 into the place where it was originally specified also using DOM functions such as appendChild( ) or by setting the innerHTML attribute of an object. In some cases missed events like, for example, ‘page load’ would need to be simulated (e.g. created and sent) for these newly added elements because these newly added elements weren't rendered and available when the actual event occurred.

The ENABLE method 200 can be either part of the browser system or included with or embedded into the rendered page itself as a script code block. In the case where the ENABLE method 200 is included with the page, the replacement data, the list of elements to enable and the associated implementation to restore, must also be included in the page.

### Known Interaction Methods

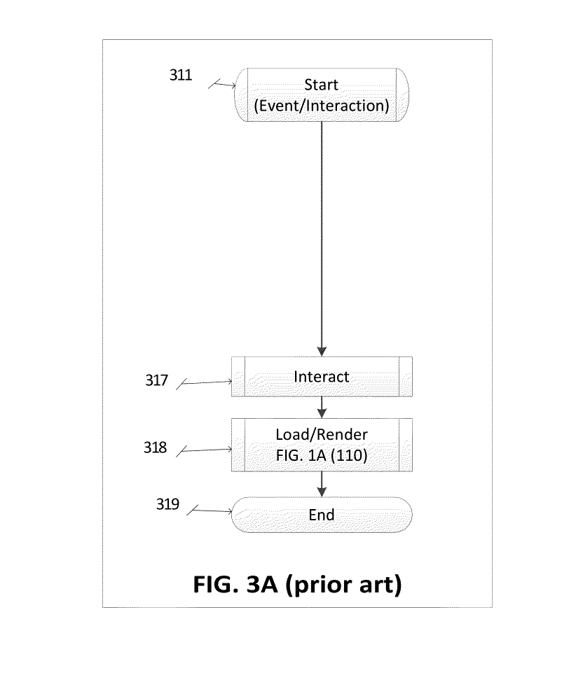

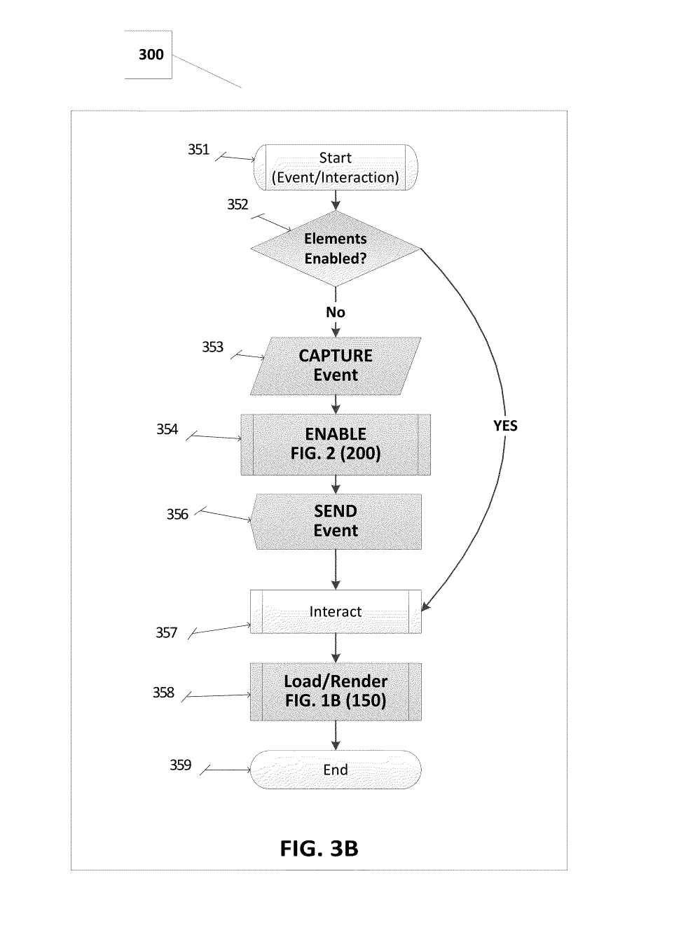

In typical systems currently known in the art, for example, as shown in FIG. 3A, once a web page is loaded and rendered into a browser window the user and /or web application server expect to be able to interact with it. This implementation is very straight-forward because interactions like keystrokes, button clicks, Asynchronous JavaScript and XML (AJAX), and other events are handled directly by elements already rendered and listening for these events. The events are therefore processed by the target element 317 which might cause more loading and rendering 318 before the interaction is complete 319.

### One-Click Interaction Method

Moving now to FIG. 3B, an example of a one-click interaction method 300 is shown. A goal of method 300 is to maintain a majority of the functionality of the original page as specified by the web application server, after the enhanced load/render operation of method 100 has completed. In one embodiment of the interaction method 300 it is an event, e.g. a click event, itself that causes the ENABLE method 200 to execute. Furthermore, the enhanced interaction method 300 provides a way so that the events which enable the original, unoptimized elements to be enabled is delayed and/or paused while the loading and rendering is completed to then be later sent to the rendered result of these newly enabled elements, allowing for a seamless switch from the optimized replacement to the originally specified and unoptimized implementation. In one embodiment, a check is made to determine if the original, unoptimized implementation has not yet been enabled 352 and if so then three functions are added to the interaction process typically performed in the current solutions: the CAPTURE interaction(s) function 353; the injection original elements function with a call to the ENABLE 200 method (block 354) and lastly, a manual SEND of events to the newly loaded element(s) 356. The CAPTURE function 353 is implemented by adding listeners to the page for any events which the rendered result of the original, unoptimized elements would be listening for and then storing the called method name and parameters in some memory array, stack or list so that they can be retrieved later once the call to the ENABLE method 200 is complete. Events are then ‘fired’ by the SEND function 356 by using the appropriate javascript functions like createEvent( ) and dispatch Event( ) or the appropriate page level functions event handlers can be called directly. Once the original, unoptimized implementation is restored, replacing the rendered result of the optimized implementation then the addition functions would be skipped 352 so that the page would respond to interactions normally as in the known method 357.

In the case where the event is a click then these steps of temporarily capturing events while the target is being enabled, allow for a seamless one-click user interface which might possibly go unnoticed to the user. This feature is unsupported and arguably impossible to implement by the techniques of privacy solutions as currently used. In alternate embodiments, user interface designs such as a two-click approach in which the user clicks once on the stub to enable the underlying button and then again to execute its functionality does not require the capturing and resending of events but also present a useful user interface because the user understands explicitly that they are turning on, or enabling, the control before they interact with it. Greying out the stub to 50% brightness and/or marking it with some icon can provide even more visual cues to the user. Again, a “click” can be a mouse click, a screen tap, a keyboard entry, a voice command or any other user selection mechanism or interaction with the system.

Implementing a one-click user interface which mirrors the original functionality requires capturing keystrokes, button clicks, AJAX, and all other events which apply to elements that have been replaced during the load/render process of one embodiment because the element(s) listening for the specific event(s) might not be loaded and/or rendered at the time when the event triggered. The solution used in one embodiment is to record all of these events and temporarily store them so that they can be played back later. In one embodiment, an in-memory array can be used, but the implementation and storage mechanism of the capture method is not limited to any specific data structure or storage mechanism. Capturing events can be implemented by registering listeners or hooking page events that the rendered result of the original, unoptimized elements would have been listening for if they were not replaced previously. Specific HTML events include “onclick”, “ondblclick”, “onmousedown”, “onmousemove”, “onmouseover”, “onmouseout”, “onmouseup”, “onkeydown”, “onkeypress”, “onkeyup”, “onabort”, “onerror”, “onload”, “onresize”, “onscroll”, “onunload”, “onblur”, “onchange”, “onfocus”, “onreset”, “onselect” and “onsubmit” as well as custom events. Determining which events to listen for is accomplished by evaluating the rendered result of the original, unoptimized elements. Any data structure and mechanism which can temporarily store a list of items can be used.

Finally, after the store and forward of events is complete, the standard behavior of the known art can take over, processing the interaction 357 and then possibly causing more load/rendering 358 before the process completes 359.

### EXAMPLES

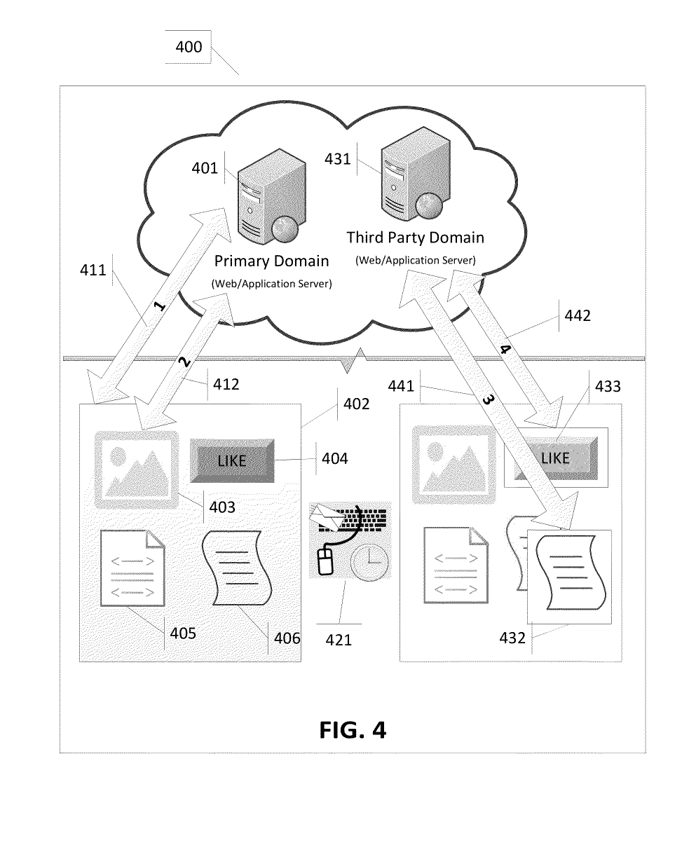

FIG. 4 shows an example 400 which illustrates how a web browser program that includes the additional steps defined in the disclosed embodiments might delay the loading and execution of a script block until the time when some event requires the functions to be available. In such an example, the primary web application server 401 sends an HTML page 402 containing some HTML text 405, a reference to an image 403 which comes from this same primary domain and a Facebook ‘Like’ button implemented by a script block 406. After the request/response 411 to the primary web server 401 is complete, the program modifies the document before it is rendered so that the Facebook script block 406 is not executed but rather is replaced by a reference to an image which loads from a local resource 404. Next the browser renders the modified HTML document 402, causing a request 412 from the primary domain server for the referenced image 403 as well as a load from some local storage for an image representing the Facebook ‘Like’ button 404. Note that the page was displayed without any references to the Third Party Domain 431, Facebook in this example.

In one embodiment, the page rendering concludes. However, consider the case in which some event occurs 421, which requires the fully implemented Facebook button. One embodiment would first hide or remove the local image 404 representing the Facebook Like button and then the stored script which references Facebook 432 is injected, rendered and allowed to run which make additional requests 441 from Facebook in order to inject an iframe which causes more requests 442 to load the resources that eventually display the page with a ‘real’ Facebook Like button 433.

### Example System

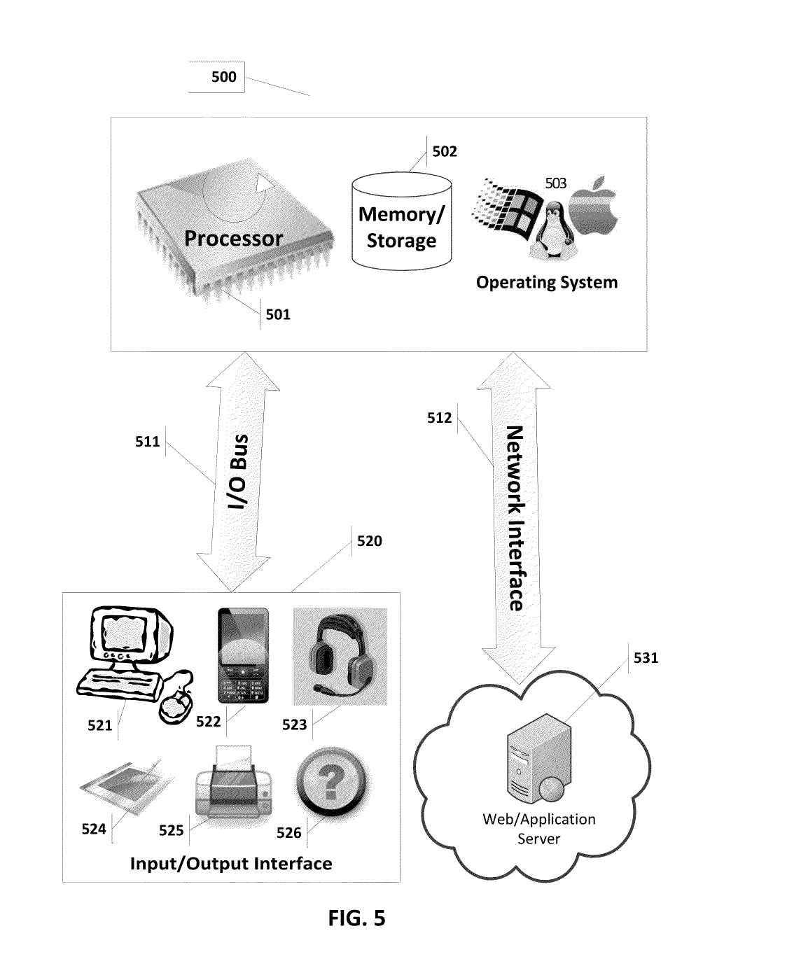

FIG. 5 illustrates one example of a system 500 which includes, at minimum, a processor 501 with some memory or storage 502 capable of running some operating system 503 that can execute the functions described in embodiments herein. Either as standalone or as part of a web browser load/render algorithm or some special purpose hardware which executes the same, I/O (input/output) interfaces 520 along with some buses and/or interfaces 511 to allow the algorithm to communicate with these I/O interfaces and a network interface 512 which allows connection and or communication with web/application servers 531. The system 500 as represented here, is intended to describe a system representative of alternative configurations and/or components not limited to the quantity and type of processors, type of storage memory or cache memory, quantity and type of interfaces, quantity and type of busses and/or bridges, etc. Furthermore, the exact nature of the I/O interface is left open. Any device 526 which can implement input and/or output is sufficient, such as, for example, a computer terminal 521, cell phone 522, speaker and/or microphone 523, tablet 524, printer 525 or any other Internet capable device that can be imagined such as common household appliances like a television, refrigerator, or even an Internet enabled washing machine which could take advantage of the increased performance and/or increased privacy offered by the disclosed embodiments.

### Flow and System of Embodiment (Browser Implementation)

The embodiments described herein can be applied to many different systems but the most common implementation is as part of a web browser program. Web browsers include browsers on phones, computers, tablets, etc. such as Microsoft's Internet Explorer, Mozilla's Firefox, Google's Chrome, Apple's Safari, Opera, etc. When the additional methods of the disclosed embodiment are applied to a web browser program, the system performs the role of a modified web browser program with all components executing in the ‘privileged’ half of the browser program. The browser program can be thought of as having two distinct halves, the program that runs at the (privileged) operating system level, directly accessing system resources and interfaces, and an unprivileged virtual machine which provides memory, a parser that can render HTML markup and execute script (programs) with limited access to a predefined set of functionality that the browser program provides.

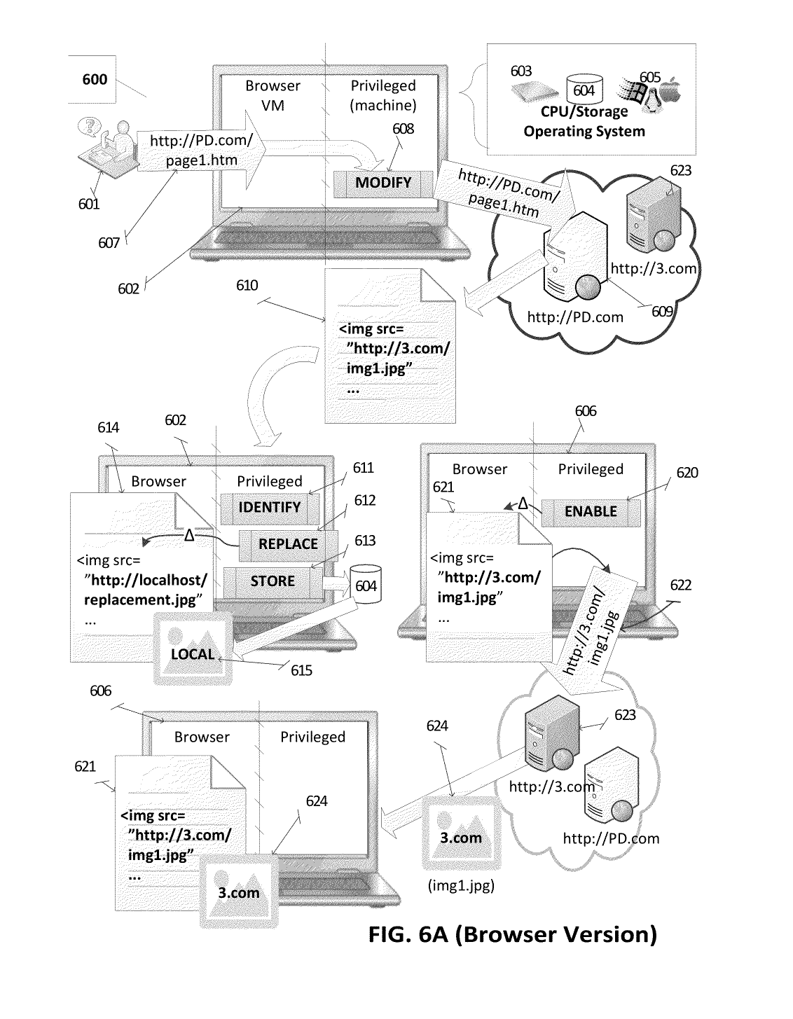

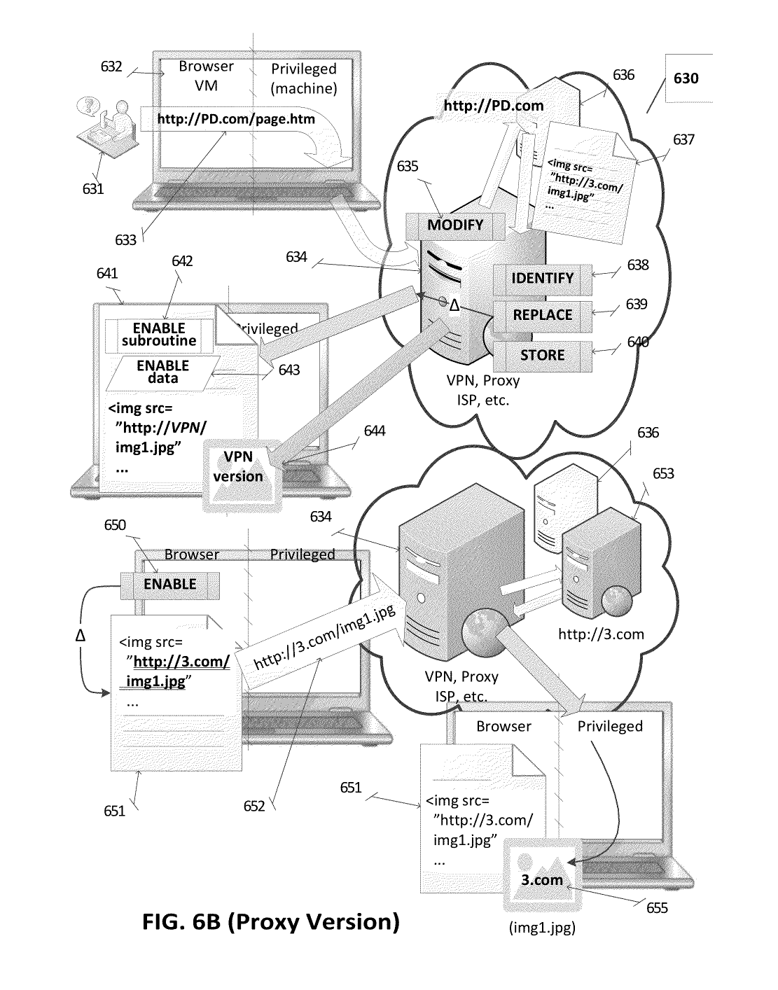

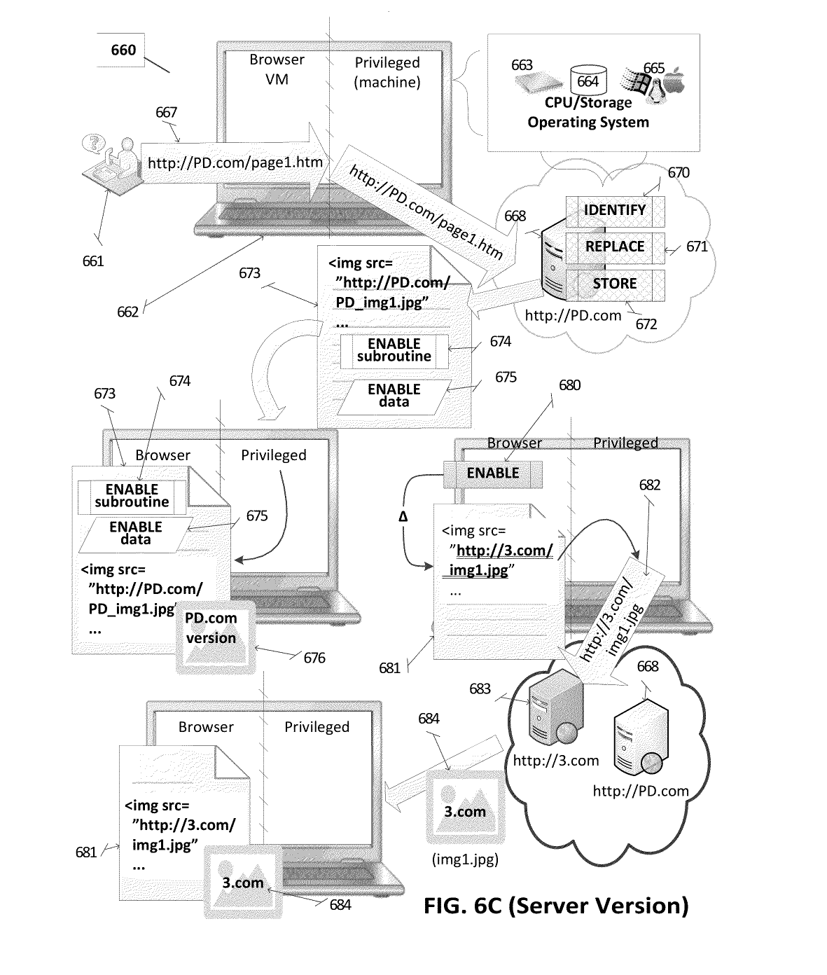

Advancing to FIG. 6A, consider a system 600 where a user 601 who has a machine 602 with one or more processors 603, memory and/or storage 604 and some operating system 605 capable of executing a browser application program, enhanced to include the additional steps of the disclosed embodiment, in which the user requests a web page, page1.htm 607, from a primary domain server PD.com 609 where the web page contains a reference to a single image img1.jpg that comes from a third party domain 3.com 623. In this example, the rendering of this image will be delayed in order to both optimize performance because the third party application server is slow and also enhance privacy by not connecting the user to the third party application server until specifically enabled.

The user 601 makes the request 607 from the browser application by specifying the fully qualified URL for the page, http://PD.com/page1.htm. Before the request is made certain request parameters and headers can be modified in order to removed or protect private information about the user and machine statistics which could be used to fingerprint the browser that the request came from. Browser fingerprinting information can include browser plugin details, time zone, screen size, screen color depth, system fonts installed, cookies and exact versions of browser and operating system. This set can be modified 608 to return the most common set, a random set or nothing at all in order to attempt to further obscure the fingerprint of the browser.

The request is then sent to the web application server of the primary domain 609, PD.com in this case. The primary web server 609 returns an HTML document 610 to the user's machine 602 which contains a reference to an image, img1.jpg, which resides on some third party server 623. Before this HTML is sent to the browser's rendering engine the third party reference is identified 611, replaced 612 with a reference to a placeholder image 615 which loads from some faster and private location (local storage 604 in this example). To be clear, the HTML page being displayed can be different from the one that came from the application server because it can be modified by the additional steps that the disclosed embodiment adds to the prior art of the load/render algorithm. The exact reference which was removed is stored 613, in this case this reference is stored in a storage location 604 which is accessible only to code running in the privileged session but it could also be embedded in the HTML page 614 and if finally rendered, is displayed for the user to see or hear, depending on the nature of the final output device.

When a case arises that the originally specified image, loaded from the third party server 623, is required then the ENABLE function 620 modifies the HTML page again, this time hiding the replacement image 615 and injecting in a reference to the original image so that the page 621 now is equivalent to the original one 610 sent by the primary application server 609. This change will cause the first reference to the third party server 623 so that it can serve up its copy of the image 624. The final result is that the originally specified document, with all originally specified references, is presented to the user.

This is a simplified example; however, consider the case when the elements being removed are scripts that load other script, load images, create popup windows, communicate private information to third parties, etc. Besides the privacy concerns, rendering these extra elements can substantially add to the amount of time required to display the page, as well as the amount of data that needs to pass across the wire.

### Flow and System of Embodiment (Proxy Implementation)

Moving now to FIG. 6B, the methods described herein can also be applied to an intermediary server based system, such as a proxy server system 630, to an ISP (Internet service provider) system, to a VPN (virtual private network) system or other system which acts as a gateway between the user's web browser program and the Internet. System 630 differs from, for example, a browser system 600 because a standard browser can be utilized. The IDENTIFY, STORE and REPLACE functions occur not as part of the browser's rendering engine but as part of some intermediary server system so that this system transforms the page before the page is received by the browser program. The system of the ENABLE function also differs because the ENABLE function executes in the browser virtual machine (unprivileged) as an embedded script and not in a privileged session as part of the browser application like in the browser system 600. This implies that the replacement data and ENABLE function must be sent along with or embedded into the page. Just like the browser system, this system can again accomplish the goals of enhancing privacy as well as performance by delaying or even completely eliminating the need to access resources from third party servers.

Considering again the example where a user 631 who has a machine or device 632 executing a standard, unmodified web browser application program where the user requests a web page 633 through an intermediary server 634 which provides the user access to the Internet. This intermediary server 634 will again contain all main components of the system 500 described previously (FIG. 5) including one or more processors, storage and a connection (bus) to the Internet. Examples of intermediary servers include a virtual private network (VPN) server, a private proxy server where a goal is to hide the IP address of the user's machine, or even an Internet Service Provider (ISP) that provides Internet access to a user's machine. Here the user's device or machine can again be any device from a personal computer to an internet enabled refrigerator to a headset that provides an audio interface to the Internet with text to speech and speech recognition to a smart cell phone.

In such a system, the request 633 is modified 635 on the intermediary server 634 to alter or remove identifying information about the user and/or the user's machine before it is passed to the primary application server 636 which returns the page back to the intermediary server 635. Here, elements which can be optimized are identified 638 and replaced 639 with alternate implementations, just like in the browser system 600. Thus, the document being returned contains an alternate reference to an image 644, one that loads directly from the proxy server in this example. The implementation details of the STORE function 640 are a little different in this system because elements are not specifically stored on the intermediary server 634 but are instead embedded as data 643 and returned in a page 641 along with script/code that implements the ENABLE function 642.

When the situation arises, either by user action, browser event, timer, etc., where elements of the originally specified page are required, then the ENABLE function is executed 650 in the browser's virtual machine, modifying the elements of the document object model (DOM) representing the HTML page currently being displayed 651. This modification of the HTML document causes the browser to make a load request 652 for an image resource residing on a third party server 653. The request goes first to the intermediary server 634 which requests the resource from the third party server 653, gets it back and then returns it to the browser so that the copy of the resource, an image in this example, from the third party server 655 can be presented to the user.

Again, this system differs from the browser embedded version in that the individual functions of the embodiment run in different locations and only a generic browser is required in this case, since no enhanced functionality is present in the browser application (privileged session). The same goals of enhancing privacy and optimizing performance are achieved for the same reasons stated earlier.

### Flow and System of Embodiment (Server Implementation)

Moving to FIG. 6C, a server system 660 is described. System 660 differs from, for example, a browser based system and a proxy server based system because the IDENTIFY and REPLACE functions can occur statically, implemented manually as part of the web page design process. The STORAGE function is similar to the proxy server system because the ENABLE method (a script block in this case) and associated data are ‘stored’ and passed along with the page, making the implementation details of ENABLE the same in both systems.

Considering the same example in which a user 661 with a machine 662 comprising one or more processors 663, memory and/or storage 664 and some browser capable of running a web browser program makes a request 667 for a web page which references a third party image. The request is passed to a web application server 668 which comprises one or more processors 663, memory and/or storage 664, an operating system, and a connection to the Internet.

In such a system 660, the web page returned 673 is modified, either statically by the web page designer, or dynamically by a process running on the web application server such that the third party reference has been IDENTIFIED 670, REPLACED 671 with a reference to an optimized resource and the data to enable the third party reference 675 as well as script to make the replacement (ENABLE function 674) has been STORED 672 and included along with the web page. In this example the optimized element references and ultimately displays the image 676 that loads directly from the same primary application server 668.

From here on the process is the same as the proxy implementation 630 with the exception that the browser application accesses resources directly from the third party server 683 and not through a proxy but ultimately the result is the same in all three implementations. In summary, the ENABLE function 680 executes, modifying the page 681 so that it now references an image from a third party server 683. The image resource 684 is loaded from the third party server 683 and ultimately presented to the user. Here again the system provides for an optimized implementation but allows for the full implementation to be enabled by the user. Such a system would be useful, for example, if WSJ.com wanted to provide the ability for its users to ‘Like’ articles on a social network without providing the means for the social network to track every interaction that its users have with the WSJ.com site.

### Additional Advantages of the Disclosed Implementations:

The embodiments and implementations described herein provide many advantages over existing privacy solutions. The most obvious advantage described in this application is performance. While the performance advantage is significant, another important advantage is that the embodiments enable and provide for much richer and alternate user interfaces not possible with the existing solutions. Furthermore, the disclosed methods and systems lessen or completely remove the current paranoia about browser cookies, which arguably significantly improves the user's web experience when allowed to work as designed.

At first glance it seems obvious why the disclosed embodiment enhances performance (fewer requests and less data need to be transferred) but this is only part of the complete solution. The approach taken by the current privacy solutions is generally to block all requests from specific domains, causing these requests to fail. This achieves the privacy goal because the user's browser never communicates with these specific third party servers but the problem with respect to performance is behind the scenes. These third party requests fail by timing out, throwing exceptions in the page or by returning errors. All of this takes time, and in some approaches the requests never finish and are left hanging, trying to complete forever. End users usually don't notice that the browser debug log or error output are filled with unhandled exceptions and/or unhandled errors caused by the use of most current day privacy solutions. In the disclosed embodiments, the code and/or element accessing third party servers are removed before any attempt is made to execute and/or render them so there are no page level errors and no requests need to be blocked.

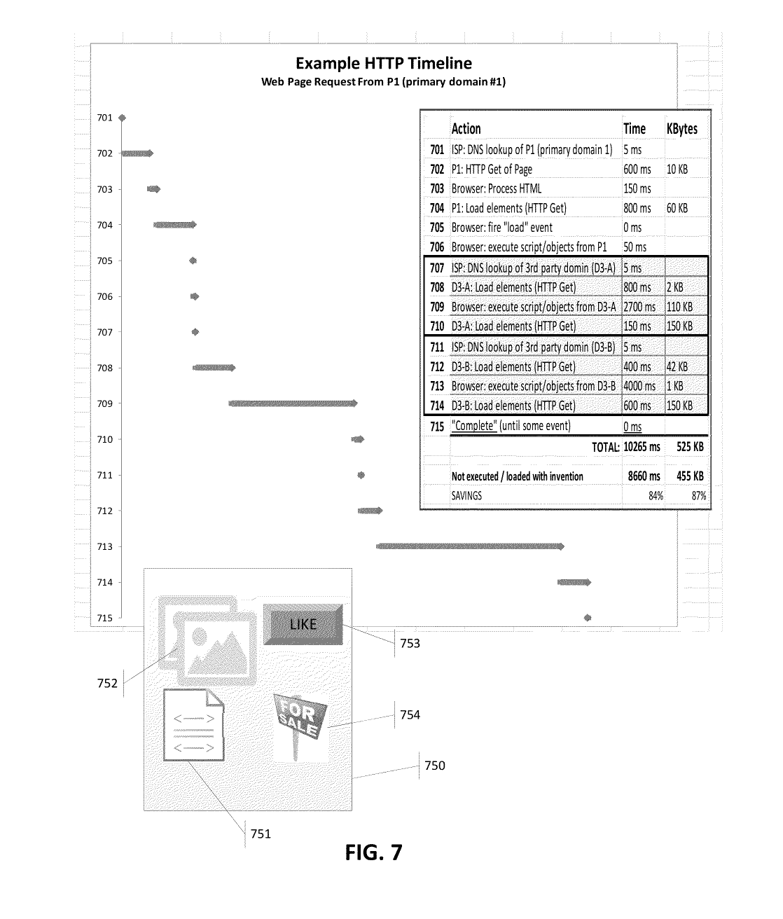

FIG. 7 illustrates the performance advantage of the embodiments by showing timing numbers from a web page containing a Facebook Like button and a Google Ad. These timing numbers are illustrative only and will vary with machine performance and Internet connection speed. A request begins with a DNS lookup 701 for the IP address of the primary domain serving up the page, then a HTTP Get request 702 is made for the page before it is then rendered by the browser 703, causing referenced elements (images in this case) to load 704 before the browser fires a load event 705 which may cause further script to execute 706. Embedded elements like a Facebook like button and Google Ad go through the same steps: ISP lookup for the IP address of the domain 707 and 711 respectively; loading of elements 708 and 712 respectively; execution of scripts and rendering 709 and 713 respectively; and finally possibly loading further elements caused by the rendering of previous elements 710 and 714 respectively. The savings by the embodiments taught herein of eliminating steps 707 through 714 saves 80+% of the load time and bytes transferred in this example, all done without causing internal page errors, load failures or timeouts, ending at step 715.

But what about the case when the user wants to ‘Like’ a page, view ads or otherwise interact with some third party elements which were blocked? Blocking requests at a protocol level is the current state of the art when it comes to enhancing privacy which requires the page to be reloaded in order to enable the blocked elements. The preferred embodiment details a superior approach whereby elements can be enabled inline but the disclosed embodiments also provide for a much improved user interface as well. Another difference with the embodiments taught herein is that they actually identify elements, usually implemented as script or code blocks, which when rendered and/or executed cause access to specific third party servers while the prior art allows the code run and then blocks access at a protocol level. Because elements are detected earlier it allows for the system and methods taught herein to understand the actual intent of the elements being blocked and replace them with an alternate and/or optimized implementation. Privacy might not even be a consideration when deciding what to replace, optimizing performance could be the entire reason a replacement is made.

The fact that embodiments disclosed herein have the ability to make replacements in the page is a significant improvement over the known solutions available today. First, the page displayed in the browser can appear visually identical to the original page that was sent from the primary web application server but without sharing information about the user (no third party script or references need to be executed) and with a significantly improved performance (e.g. data can be loaded from local storage). The user of a privacy solution from prior art might not have any idea that the page contained a social networking control other than noticing broken formatting or a popup alert notifying the user that some third party domain was blocked. One embodiment goes further to provide methods to restore or enable blocked elements in place, dynamically and without the need to refresh the page. FIG. 2 details how an event, menu item or even a click on the page could cause for the originally defined elements or a group of elements to be dynamically injected and rendered in a page, replacing some optimized implementation, all without reloading the page. If the approach to blocking elements is to block the request then the request must be repeated (page reloaded) in order to enable specific elements. FIG. 3B shows a 1-click approach whereby a user can click on a stub causing the originally-defined elements and associated script to load, render and receive the click. In such a system, the user might not even be aware that the page was any different from the original as it can be key by key, click by click and visually identical, another user interface which is not possible with the prior art. No annoying pop-ups are required as with the prior art, forcing the user to understand what's going on and answering technical questions about what to enable and what to block —the user can just go about using the page as he or she would normally.

Finally, one embodiment modifies headers when appropriate just like the prior art so that cookies can be less effective but the fact that third party elements and/or code don't load and/or run actually makes the header modification step (MODIFY function) less relevant to a system implementing these embodiments.

### Future Problems and Solutions

While the disclosed embodiments aim to circumvent other systems and methods, it is virtually impossible for other systems and methods to circumvent the disclosed embodiments because the disclosed embodiments “get there” first. More specifically, any code included with a web page which would try to circumvent the methods and systems disclosed herein could be identified and replaced by these disclosed methods and systems before any such code is allowed to execute. To stay current, as new features of existing third parties as well as new third party players are created, all that must be done is to add to and modify the library of signatures that are detected along with the associated replacements. If, for example, Twitter created a new widget or changed the look of an existing widget then the identification logic and replacement stub would both have to be modified to stay up with the current version otherwise detections would be missed and/or the page would not appear as intended. The system and methods disclosed herein, however would not change, only the library of detections and replacements.

### CONCLUSION

The foregoing disclosure details a method and systems to enhance web browser performance and/or increase user privacy by selectively loading and rendering only the necessary parts of the page as required by the user. Furthermore, provided are methods, apparatus, and systems so that the optimized page can retain all functionality, look and feel of the original. In the included embodiments, initially only elements identified as being required in the most general case and/or which do not share private information about the user are loaded and rendered. Then additional elements are loaded and rendered as requested by other events or direct user interaction with the browser application or web page. The removed elements can be replaced with placeholders which could visually appear exactly the same as the original element but without accessing a web application server at all. Unnecessary, poorly performing and privacy violating elements can then be dynamically loaded and rendered to provide additional functionality as needed.

The foregoing description of the embodiments of the invention as well examples of how it can be applied and implemented is for illustrative purposes only and is not meant to be exhaustive. Alternate systems, application and stringing together of some or all of the components of the embodiments are also possible. The language used here and sample code clips are again for illustrative purposes only and are not intended to limit the scope of the invention which is set forth by the following claims.

It is to be recognized that depending on the embodiment, certain acts or events of any of the methods described herein can be performed in a different sequence, may be added, merged, or left out completely. Not all described acts or events are necessary for the practice of the method. Moreover, in certain embodiments, acts or events may be performed concurrently, for example, through multi-threaded processing, interrupt processing, or multiple processors, rather than sequentially.

Those of skill in the art will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application and embodiment.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While the above detailed description has shown, described, and pointed out novel features of the improvements as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A method, the method comprising:
receiving a web page description;
identifying original elements that can be optimized;
transforming the elements, replacing the original elements with optimized elements; and
outputting a new page description, wherein the optimized elements are rendered.

2. The method of claim 1, wherein the identified elements are stored so that the original, unoptimized elements can be enabled later.

3. The method of claim 1, wherein the identified elements are elements which degrade performance or share identifying information.

4. The method of claim 1, wherein the optimized elements improve performance of web page rendering or hide identifying information.

5. The method of claim 1, wherein the optimized elements, when rendered, are visually similar to the rendered result of the original, unoptimized elements that were replaced, preserving an intended page layout.

6. A method, the method comprising:
receiving a rendered web page containing a rendered result of optimized elements and information necessary to enable original, unoptimized elements;
waiting for an event;
transforming the rendered web page, replacing the rendered result of the optimized elements with the original, unoptimized elements; and
rendering the original, unoptimized set of elements, thereby generating the originally specified web page.

7. The method of claim 6, further comprising:
capturing the event, wherein the event is one for which the rendered result of the original, unoptimized elements would be listening if it had it been rendered;
waiting for the unoptimized elements to finish rendering; and
sending the event to the rendered result of the original, unoptimized elements.

8. The method of claim 7, wherein the event is a click on the rendered result of the optimized elements, resulting in a single-click interface for both activating the original, unoptimized elements and sending a click event to the rendered result of the originally specified, unoptimized elements.

9. A system, the system comprising:
at least one non-transitory memory;
one or more processors;
one or more network interfaces;
logic encoded, such that the processors:
intercept web page descriptions;
identify original elements that can be optimized; and
transform the original elements, replacing the original elements with optimized elements, generating a modified web page description.

10. The system of claim 9, wherein the system is providing web browsing functionality and also comprises:
one or more output interfaces; and
one or more input interfaces;
wherein the processors render the modified web page description on the one or more output interfaces.

11. The system of claim 9, wherein the system serves the role of one of a web application server, an intermediary server such as a proxy server, a virtual private network (VPN) or an internet service provider (ISP); and the modified web page description is returned to a requestor via the one or more network interfaces.

12. The system of claim 9, wherein the identified elements are elements that degrade performance or share identifying information.

13. The system of claim 9, wherein the optimized elements improve performance of web page rendering or hide identifying information.

14. The system of claim 9, wherein the optimized elements reference elements which can load from optimized locations including at least one of the system's non-transitory memory, an alternate third party server, a local resource of the browser rendering the page, and as binary data encoded and included inline in the optimized page description.

15. The system of claim 9, wherein the optimized elements, when rendered, are visually similar to the rendered result of the original, unoptimized elements that were replaced, preserving the intended page layout.

16. The system of claim 9, wherein the processors store the identified elements in the non-transitory memory so that they can be enabled and rendered later.

17. The system of claim 9, further comprising a modified web page description including the identified elements needed to enable the original, unoptimized elements which were replaced along with instructions which, when executed by a web browser, can enable and render the original, unoptimized elements.

18. The system of claim 9, wherein an event triggers the processors to enable the original, unoptimized elements.

19. The system of claim 9, wherein the processors:
capture an event, wherein the event is one for which the rendered result of the original, unoptimized elements would be listening if it had it been rendered;
enable the original, unoptimized elements;
wait for the original, unoptimized elements to finish rendering;
send the event to the rendered result of the original, unoptimized elements.

20. The system of claim 19, wherein the event is a click on the rendered result of the optimized elements, resulting in a single-click interface for both activating the original, unoptimized elements and sending a click event to the rendered result of the originally specified, unoptimized elements.
